(19) United States
(12) Patent Application Publication
(10) Pub. No.: US 2008/0193727 A1
(43) Pub. Date: Aug. 14, 2008

(54) Method of Laminating a Fragrance onto a Substrate and Product Constructed by said Method

(75) Inventor: Robert Bernstein, Somers, NY (US)

Correspondence Address: LEVINE & MANDELBAUM, 444 MADISON AVENUE, 35TH FLOOR, NEW YORK, NY, 10022, US

(73) Assignee: SCENTISPHERE LLC, Carmel, NY (US)

(21) Appl. No.: 12/027,422

(22) Filed: Feb. 7, 2008

Related U.S. Application Data
(60) Provisional application No. 60/889,100, filed on Feb. 9, 2007.

(51) Int. Cl. B32B 5/16; B29C 65/00

(52) U.S. Cl. 428/206; 156/276

(57) ABSTRACT

A pull-apart fragrance sampler laminate is constructed by dispersing microcapsules containing fragrance oil into a quick setting adhesive. The resulting dispersion is applied to a surface of a substrate and then covered with an overlayer. The substrate and overlayer adhere to the dispersion until they are pulled apart whereby the microcapsules are fractured, releasing the fragrance. The substrate may be a continuous web of two-layer stock having a silicone coated liner and a release layer on which the dispersion is coated for making fragrance samplers in the form of die cut labels. The dispersion may be applied to the substrate by a relief printing plate at a station of a printing press through which the substrate and cover layer are transported.

### BACKGROUND OF THE INVENTION

The present invention is directed to a method of laminating a fragrance onto a substrate and a laminate constructed by the method. More specifically, the invention teaches a method of applying to a substrate, a scented adhesive over which a separate layer of material having no previous connection to the substrate can be applied to form a structurally stable laminate which can be cut and delivered for releasing a fragrance upon separation of the laminate.

It is known in the art to apply a suspension of a scented oil mixed in a liquid non-evaporating gel to a substrate and to place a flexible laminate over the suspension. The space which contains the suspension must be sealed around its edges to maintain the scented suspension between the laminated surface and substrate in order to prevent the suspension from oozing between the laminate and substrate thereby creating a mess. An airtight seal is critical to the function of delivering a scent for sampling via a label or card construction. If the gel leaks from the seal, the scent oil will evaporate and the gel is likely to stain the surface to which it is applied. Most prior art multiple web-layer products require a permanent glue around the perimeter of the fragrance suspension to seal the laminate. With the latter type of construction, the fragrance has to be touched in order to experience the scent.

In an alternative prior art construction, a micro encapsulated scent in powdered form is encased between a substrate and laminate much like the above described construction wherein the fragrance is in a suspension or gel. This product also requires that there be a seal around the edges of the space wherein the fragrance is stored. Also, as in the case of the sealed gel fragrance, experiencing the scent requires that the consumer open the package thereby touching the fragrance to activate its scent.

There is known in the prior art a construction for releasing a scent where fragrance need not be encased in a sealed space or touched to activate its scent. In this type of construction, a microencapsulated fragrance is suspended in a runny adhesive, and then a strip of the fragrance-containing adhesive is coated onto a thin paper substrate adjacent one of its edges. The paper is then folded over upon itself thereby sandwiching the strip of fragrance-containing adhesive within the fold. The edge of the fold secures the two layers of paper sufficiently to prevent mutual shifting while the adhesive is allowed to dry. If the two layers are not part of a single folded sheet, they must first be affixed to one another, e.g., by an adhesive which must be set before the fragrance-adhesive mixture is applied, at least temporarily, to prevent shifting while the fragrance-adhesive mixture is drying. In order to maintain the necessary pressure between the layers while drying takes place, it is necessary to place a weight upon them, or if numerous such paper constructions are being made, to keep them in a stack until the adhesive dries. Examples of such constructions are provided in U.S. Pat. No. 4,487,801 to Turnbull et al. for a Fragrance-Releasing Pull-Apart Sheet, U.S. Pat. No. 4,720,417 to Sweeny et al. for a Fragrance-Releasing Pull-Apart Sheet, and U.S. Pat. No. 4,988,557 to Charbonneu for a Fragrance Sampling Device.

The latter method is suitable for making inserts for use in magazine publications. However, the method is not suitable for making a scented multi-web label or a card incorporating a microencapsulated fragrance. Similarly, the method does not permit application of a microencapsulated fragrance to substrates other than those made of thin paper.

In another construction, adhesion between polystyrene and the gelatin based capsules in which a fragrance oil is encapsulated is relied upon to cause the capsules to rupture when the layers between which they are disposed are torn apart. U.S. Patent Publication No. 2004/0096486 by Tararuj for a Pull Apart Fragrance Sampler discloses such a construction where each of the layers is formed from a polystyrene or similar plastic film, or a paper coated with such a plastic film. The fragrance containing microcapsules adhere to the film layers or coatings and are fractured when the layers are pulled apart.

The foregoing construction cannot employ uncoated paper, cardboard, or even plastic materials which do not fuse with or adhere to the gelatin material from which fragrance microcapsules are formed. The requirement that the layers adhere to the microcapsules severely limits the range of applications for the construction.

### SUMMARY OF THE INVENTION

The aforementioned shortcomings of prior art scented media are overcome by the present invention which provides a method for making scented media by dispersing within a low viscosity suspension of polymers, solid adhesives and water, microcapsules containing a fragrance in the form of a scented oil. The resulting dispersion is an adhesive which sets virtually instantly when applied between a substrate and a cover layer of paper, plastic, or virtually any other sheet material. When the cover layer is torn away from the substrate, the microcapsules burst thereby releasing a scent from the encapsulated fragrance.

It is therefore an object of the invention to provide a method for manufacturing a medium having multiple layers which are joined by an adhesive containing an encapsulated fragrance.

Another object of the invention is to provide a method for manufacturing a multilayered medium from which a scent can be released by separating the layers of the medium.

Still another object of the invention is to provide a method for manufacturing a multilayered medium from layers of different materials of differing thicknesses.

A further object of the invention is to provide a method for applying a scent-releasing dispersion to a plastic substrate.

Still a further object of the invention is to provide a method for applying a scent-releasing dispersion with a relief printing plate.

It is also an object of the invention to provide a multilayered medium made of layers of different materials between which an encapsulated fragrance can be disposed for release of a scent when the layers are separated.

Still also an object of the invention is to provide a medium made of layers at least one of which is transparent and another of which is imprinted and visible through the transparent layer, and between which an encapsulated fragrance can be disposed for release of a scent when the layers are separated.

Other and further objects of the invention will be apparent from the following drawings and description of a preferred embodiment of the invention in which like reference numerals are used to indicate like parts in the various views.

### DESCRIPTIONS OF THE DRAWINGS

FIG. 1 of the drawings is a schematic side elevation view of a printing press adapted to perform the method of the preferred embodiment of the invention;

FIG. 2 of the drawings is a schematic side elevation view of a partially completed product in accordance with the preferred embodiment at an early stage of manufacture in accordance with the method of the preferred embodiment of the invention;

FIG. 3 of the drawings is a schematic side elevation view of the partially completed product of FIG. 2 at a later stage of manufacture in accordance with the method of the preferred embodiment of the invention; and

FIG. 4 of the drawings is a plan view of the product of FIG. 2 at a completed stage of manufacture in accordance with the method of the preferred embodiment of the invention.

### DESCRIPTION OF THE PREFERRED EMBODIMENT

The method of the invention accomplishes the manufacture of a die cut stick on label, a hand out card, or a similar construction that allows consumers to sample the scent of a marketer's product by pulling apart two layers of the construction. This is accomplished through the use of a quick-setting adhesive in which a microencapsulated fragrance is dispersed. The scent is released when microcapsules in which the fragrance is stored are fractured by tearing apart two substrate layers which are glued together by the adhesive. The product of the invention, which is made by the method of the invention, enables a scent to be released by a consumer for sampling without any necessity for touching the mixture in which the fragrance is dispersed.

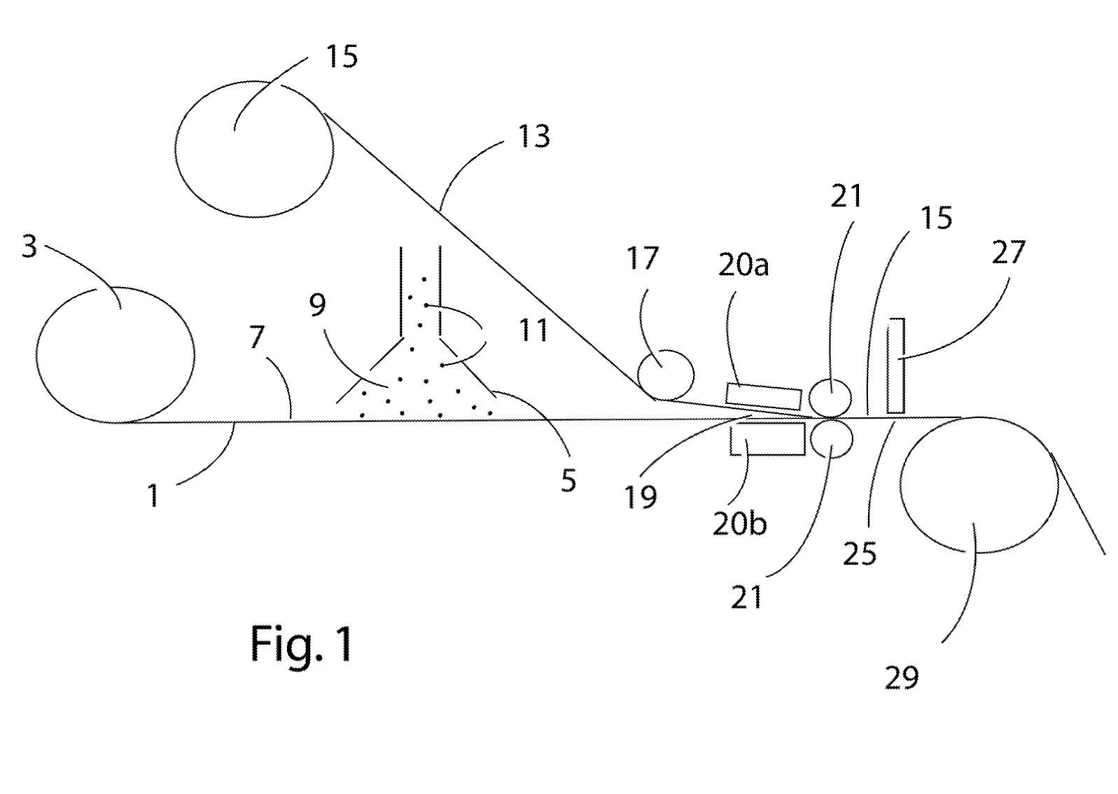

Referring now to FIG. 1 of the drawings, a continuous web of a conventional pressure sensitive separable two-layer stock 1 wound on a spool 3 is passed to a first station 5 at which the upper surface 7 of the web 1 is coated with a composition 9 in the form of a dispersion of an adhesive in which microcapsules 11 containing a scented oil are dispersed.

The adhesive can be a semi-fluid material, white in color, with a viscosity of approximately 5000 cgs, and pH of approximately 4.0, and a density of approximately 9 pounds per gallon. Such an adhesive is commercially available from the National Adhesives division of National Starch and Chemical Company under the trademark IMPERVO, product no. 14-9051. The viscosity, pH and density may each be in the range of −20% to +20% of the preferred values stated above.

The scented oil microcapsules are commercially available from Follmann & Co. in Germany, and are sold under the trademark FOLCO.

The adhesive can be prepared by mixing the microcapsules into the adhesive in a paddle mixer preferably operating at 500-1,500 r.p.m. with 1,000 r.p.m. having been found to yield optimum results. The mixture includes approximately 20% microcapsules and 80% adhesive by volume.

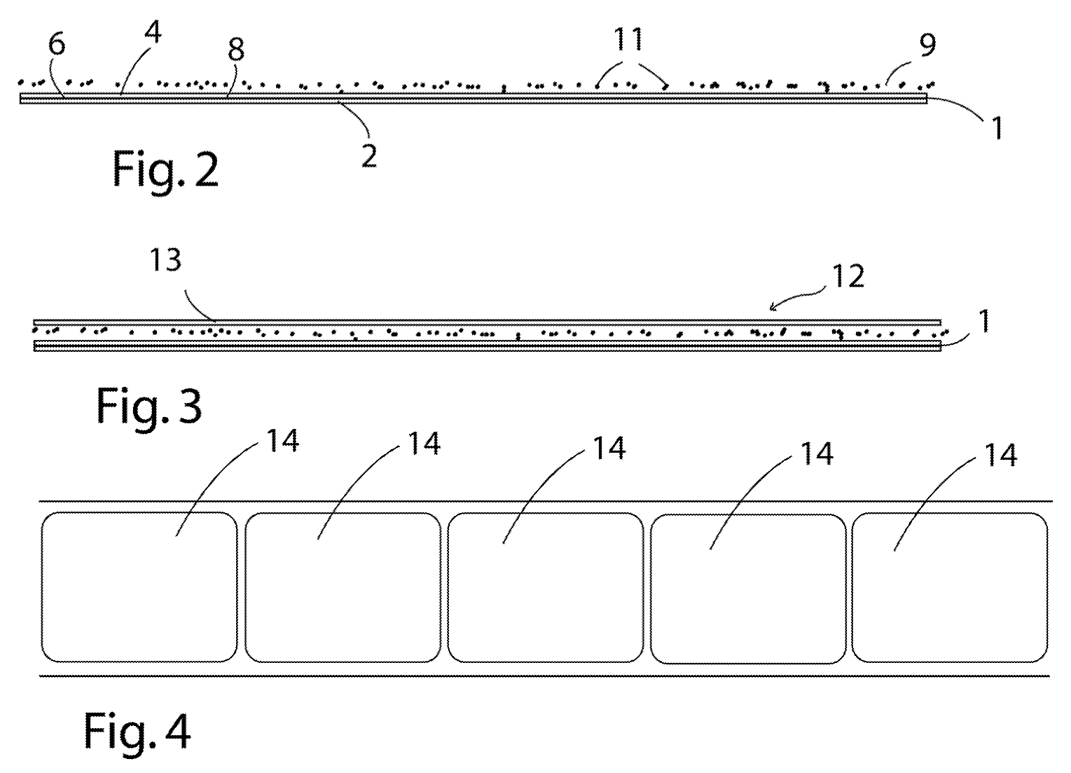

The station 5 can include a relief printing plate for applying the dispersion much in the way ink is applied in a conventional relief printing press. As the web 1 leaves station 5 it has the appearance shown in FIG. 2.

The lower layer 2 of the two-layer stock 1 has an upper surface 6 coated with a silicone release formulation and serves as a liner for the upper layer of the two-layer stock 1. The upper layer 4 of the two-layer stock 1 has a lower surface 8 that is uniformly coated with an adhesive 10 having a greater affinity for the lower surface 8 of the upper layer 4 than for the silicone coated upper surface 6 of the lower layer 2. Hence, the liner lower layer 2 is releasably attached to the top layer 4 by the adhesive 10.

Immediately after the application of the scented dispersion 9 to the two-layer base web 1, a second web of single layer un-gummed paper 13, wound on a spool 15, is applied on top of the dispersion 9, thereby forming a laminate 12 in which the dispersion 9 is sandwiched between the dual layer web 1 and the single layer web 13 as shown in FIG. 3. The adhesive 9 rapidly dries with the scented microcapsules 11 and the polymers of the dispersion adhered to the facing surfaces of the webs 1 and 13.

The adhesives in the sticky dispersion 9 create an instant bond between the webs 1 and 13. This instant bond is required so that the two webs 1,13 will not separate or shift with respect to one another when the laminate is printed, die cut, rolled or cut into sheets.

The single layer un-gummed paper 13 is passed under a roller 17 and through a tapered gateway 19 formed by guides 20a,b through which the two-layer base web 1 also travels. Pinch rollers 21 are separated by a distance short enough to cause the dispersion 9 coated on the upper surface of the two-layer base web 1 to come in contact with the lower surface of the un-gummed paper 13, as shown in FIG. 1. The distance between the pinch rollers 21 is, however, large enough to prevent the fragrance-containing microcapsules 11 from being crushed or otherwise fractured. Hence as the laminate 15 exits the pinch rollers 21, the microcapsules 11, within the dispersion 9 to which the webs 1 and 13 are adhered, retain the fragrance oils encapsulated within them.

The laminate 15 then travels to a die cutting station 25 where cutters 27 remove from the laminate, around the intended area of the labels 14 to be formed, a portion of the upper layer 13 and the top layer 4 of the web 1 with the dispersion 9 therebetween. The web 1, with labels 14 releasably adhered to its silicone surface 6, as shown in FIG. 4, is then passed over a delivery roller 29 after which the web 1 with its labels 14 can be spooled or cut, as may be desired.

The labels can then be removed from the web 1 and affixed to any surface, e.g., a page of a magazine, a catalog, direct mail cards or the surfaces of products or their packaging, for enabling a consumer to sample the scent of the encapsulated fragrance. The adhesive 10 under each label 14 provides a stronger bond to the paper or other substrate on which it is ultimately mounted than the bond between the webs 1 and 13. When the top layer 13 is removed from the label, the tearing apart of the two substrates 1 and 13 breaks the scented microcapsules 11 thereby releasing the scent of the fragrance contained within the microcapsules.

In addition to being made from paper, the web 1 can be a single layer of flexible or semi-rigid plastic. If the plastic is transparent, as is preferred, the laminate can be applied over a printed surface. The printing is then visible through the laminate.

In order to enhance the bond between the adhesive 9 and upper surface of the plastic web, the upper surface of the plastic web can be subjected to a high voltage discharge for scoring the surface prior to application of the adhesive 9. This treatment increases the surface tension of the plastic web and makes it more receptive to the dispersion 9.

The web 1 can be formed from a single layer card stock or other material heavier than conventional paper. The finished laminate can then be cut into cards and distributed as inserts or in mailers.

It is to be appreciated that the foregoing is a description of a preferred embodiment of the invention to which alterations and modifications may be made without departing from the spirit and scope of the invention.

What is claimed is:

1. A method of making a fragrance sampler by laminating a fragrance onto to a substrate comprising
mixing into a rapid-setting first adhesive a plurality of microcapsules each of which contains a scented medium to form a scent-containing dispersion,
coating an area of a surface of said substrate with said dispersion,
placing over and in spaced relationship to said dispersion on said substrate a cover layer, said cover layer initially making no contact with said substrate, and
pressing said cover layer against said dispersion on said substrate with a force insufficient to fracture said microcapsules thereby forming a laminate with said edges of said cover layer and said substrate unsealed except by said set first adhesive in said dispersion therebetween.

2. A method according to claim 1 wherein said first adhesive comprises a semi-fluid material with a viscosity in the range of 4000 cgs to 6000 cgs.

3. A method according to claim 2 wherein said first adhesive comprises a semi-fluid material with a viscosity of substantially 5000 cgs.

4. A method according to claim 1 wherein said first adhesive comprises a semi-fluid material with a pH in the range of 3.2 to 4.8.

5. A method according to claim 1 wherein said first adhesive comprises a semi-fluid material, with a pH of substantially 4.0.

6. A method according to claim 1 wherein said first adhesive comprises semi-fluid material with a density in the range of 7.2 pounds per gallon to 10.8 pounds per gallon.

7. A method according to claim 6 wherein said first adhesive comprises semi-fluid material with a density of substantially 9 pounds per gallon.

8. A method according to claim 1 wherein at least one of said substrate and said cover layer comprises uncoated paper.

9. A method according to claim 1 wherein at least one of said substrate and said cover layer is free of plastic.

10. A method according to claim 1 wherein said substrate comprises a first continuous web fed from a first roll and said cover layer comprises a second continuous web fed from a second roll displaced from said first roll, said first web and said second web being passed between pinch rollers for pressing said cover layer against said dispersion on said substrate.

11. A method according to claim 10 further comprising passing said first web through a coating station whereat a surface of said first web is coated with said dispersion before said first web and said second web are passed between said pinch rollers.

12. A method according to claim 11 further comprising applying said dispersion to said first web at said coating station with a relief printing plate.

13. A method according to claim 10 wherein said first web comprises a first layer and a second layer removably affixed to said first layer by a second adhesive having a greater affinity for said second layer than for said first layer whereby said first layer can be peeled away from said second layer leaving said second adhesive on said second layer for affixing said second layer with said cover layer and said dispersion to a surface.

14. A method according to claim 13 further comprising forming labels from said second layer, cover layer and dispersion therebetween by removing from said laminate around an intended area of said labels to be formed, a portion of said cover layer and said second layer of said first web with said dispersion therebetween.

15. A method according to claim 14 wherein said portion of said cover layer and second layer of said first web with said dispersion therebetween are removed by die cutting.

16. A fragrance sampler for sampling a scent comprising,
a substrate,
a cover layer, and
disposed between said substrate and said cover layer, a rapid-setting first adhesive in which there are dispersed a plurality of microcapsules each of which contains a scented medium, said substrate and said cover layer having respective edges unsealed except by said set first adhesive in said dispersion therebetween.

17. A fragrance sampler according to claim 16 wherein said first adhesive comprises a semi-fluid material with a viscosity in the range of 4000 cgs to 6000 cgs.

18. A fragrance sampler according to claim 17 wherein said first adhesive comprises a semi-fluid material with a viscosity of substantially 5000 cgs.

19. A fragrance sampler according to claim 16 wherein said first adhesive comprises a semi-fluid material, with a pH in the range of 3.2 to 4.8.

20. A fragrance sampler according to claim 19 wherein said first adhesive comprises a semi-fluid material, with a pH of substantially 4.0.

21. A fragrance sampler according to claim 16 wherein said first adhesive comprises semi-fluid material with a density in the range of 7.2 pounds per gallon to 10.8 pounds per gallon.

22. A fragrance sampler according to claim 21 wherein said first adhesive comprises semi-fluid material with a density of substantially 9 pounds per gallon.

23. A fragrance sampler according to claim 16 wherein at least one of said substrate and said cover layer comprises uncoated paper.

24. A fragrance sampler according to claim 16 wherein at least one of said substrate and said cover layer is free of plastic.

25. A fragrance sampler according to claim 16 wherein said first web comprises a first layer and a second layer removably affixed to said first layer by a second adhesive having a greater affinity for said second layer than for said first layer whereby said first layer can be peeled away from said second layer leaving said second adhesive on said second layer for affixing said second layer with said cover layer and said dispersion to a surface.

26. A fragrance sampler according to claim 25 in the form of a label comprising said second layer, second adhesive, cover layer and dispersion between said cover layer and said second layer, said dispersion and said second adhesive being disposed on opposite surfaces of said second layer whereby said second layer of said label can be affixed to a surface.
